(19) United States
(12) Patent Application Publication
(10) Pub. No.: US 2005/0270151 A1
(43) Pub. Date: Dec. 8, 2005

(54) RF interconnected HVAC system and security system

(75) Inventor: Steven J. Winick, Woodmere, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 11/170,403

(22) Filed: Jun. 29, 2005

Related U.S. Application Data
(63) Continuation-in-part of application No. 10/646,642, filed on Aug. 22, 2003, now abandoned.

(51) Int. Cl. G08B 1/08; H04Q 7/00; F24F 7/00

(52) U.S. Cl. 340/539.1; 236/49.3

(57) ABSTRACT

An interconnected wireless HVAC (heating, ventilation, air conditioning) system and wireless security system, which are interconnected and communicate with each other through the use of a common wireless technology, including the same selected frequency, modulation and a set of common protocols. The Wireless HVAC system includes wireless thermostats, which can communicate with and control both the HVAC system and the security system, and the wireless security system includes wireless controls or keypads, which can communicate with and control both the security system and the HVAC system. The universal wireless infrastructure can be expanded to provide communication or control of additional user or manufacturer installed wireless devices or systems through the universal wireless home infrastructure.

### RELATED APPLICATIONS

The present disclosure is a continuation-in-part of U.S. patent application Ser. No. 10/646,642 filed Aug. 22, 2003.

### BACKGROUND OF THE DISCLOSURE

1. Field of the Disclosure

The present disclosure relates generally to an interconnected HVAC (heating, ventilation, air conditioning) system and security system, and more particularly pertains to an interconnected wireless HVAC system and wireless security system which are interconnected and communicate with each other through the use of a common wireless RF technology, including the same selected frequency, modulation and a set of common protocols.

The wireless HVAC system includes wireless thermostats, which can communicate with and control both the HVAC system and the security system, and the wireless security system includes wireless control keypads, which can communicate with and control both the security system and the HVAC system. Moreover, the universal infrastructure can be expanded with additional user or manufacturer installed wireless devices or systems to provide communication or control of the additional user or manufacturer installed wireless devices or systems through the universal home infrastructure.

2. Discussion of the Prior Art

Managing temperature and other environmental conditions is a task that is of importance both for the comfort of those in the environment and for the minimization of operating cost. An environment's temperature is generally regulated such that the environment is comfortable, with individuals in the environment desirably making selections to temperature and other settings to attain personal levels of comfort. Individuals may not only seek to regulate temperature to a specific and predetermined suitable temperature, but may seek to vary temperature with time of day or week, or to vary environmental control parameters other than temperature.

In some applications, heating and air conditioning equipment controls may allow customization of more detailed functions of climate control in order to better control system operation and efficiency. For instance, fans in heating or cooling systems may be controlled to run for a period beyond when the heating or cooling device is active, and may be set to run for specified minimum and maximum times. Activation of these climate control systems may be dependent upon the temperature falling out of a specified range of temperatures, and such activation may be triggered differently by each of a number of thermostats within an environment. Different degrees of control over such climate control systems may also be allowed at each thermostat's manual controls, such that individuals using a particular area of a facility may only adjust the climate control system within predetermined operational specifications.

While various input devices for environmental control systems have been employed to achieve environmental control, these input devices have generally been limited in their breadth and complexity. Many previously available environmental controls provide generally limited functionality to individual users, with certain control functions being difficult for typical lay users to understand and implement. For example, conventional programmable thermostats are generally limited in their functionality to relatively few and simple inputs. Setting multiple thermostats in an environment can require further work, visiting each thermostat in question and making or verifying appropriate settings. For instance, in a dwelling controlled using several thermostat controls, each control must typically be physically visited to change settings such as temperature settings, time of day settings, vacation settings (i.e., setting all thermostats to energy-conserving settings) and others. In addition, these controls have generally been limited in application to the communication of climate control signals to and from climate control systems, and tend not to be readily integrated into other systems.

In the present state of the art, there is no simple and effective way to interconnect an HVAC system, which is typically controlled by thermostats, with a security system, which is typically controlled by keypads. This problem with interconnectivity is made even more complex when the realities of market distribution channels are considered and recognized. For example, a security installation company typically is not willing to install anything that affects the home HVAC (heating, ventilating, air conditioning) system or to connect to or program an HVAC system. Similarly, an HVAC installer typically is not willing to install anything that affects the home security system or to connect to or program a security system. Moreover, neither type of installer is willing to install a bridging device between the security system and the HVAC system.

Programmable thermostats are commonly available at the present time, but share a common problem. Their user interfaces are generally very basic and simple, making programming and usage difficult, such that most users cannot take full advantage of the features and functions of the programmable thermostats. In addition, present thermostats are limited in the extent of the information they can display, typically confined to the temperature set points and the currently sensed temperature. They can't sense or display the temperature in other rooms, outdoor temperature, or air quality for example. In addition, present thermostats cannot be remotely controlled from other rooms or from mobile locations within a home, and are typically limited to regulating temperature based on sensed information at the thermostat location. The prior art literature also discloses thermostats for HVAC systems provided with a GUI (graphical user interface), and thermostats communicating with an HVAC system by a short range RF transceiver.

### SUMMARY OF THE DISCLOSURE

Accordingly, it is a primary object of the present disclosure to provide an interconnected HVAC (heating, ventilation, air conditioning) system and security system.

The HVAC system incorporates a wireless control system using a selected wireless communication technology, such as RF (Radio Frequency), Infrared (IR), etc., modulation and a set of protocols (e.g., 802.11x, Bluetooth, IRDA, etc.), and includes at least one wireless thermostat having an transceiver for communicating with and controlling the HVAC system. Preferably, the system utilizes RF in conjunction with either one of the 802.11 variants or Bluetooth, however, as new wireless technologies and protocols become feasibly available for commercial applications—and in as much as they are capable of providing at least the functionality disclosed herein—they too are considered applicable to the present disclosure. The HVAC system can also incorporate one or more wireless CO sensors and wireless smoke or fire detectors.

The security system also incorporates a wireless control system using the same selected wireless technology and modulation as the HVAC wireless control system, and also using a set of protocols, which includes a set of standard protocols common to both the HVAC system and the security system. The security system further includes at least one wireless control keypad for communicating with and controlling the security system. The security system can also incorporate one or more wireless CO sensors and wireless smoke or fire detectors. Pursuant to the present disclosure, the common wireless technology, modulation and set of common protocols provide interconnectivity and communication between the HVAC system and the security system.

In greater detail, the HVAC system is controllable from the security system wireless keypads, and the security system is controllable from the wireless thermostats. The security system includes room occupancy sensors, typically IR sensors for sensing the presence of occupants in rooms, and the room occupancy sensors of the security system can advantageously be used to control the HVAC system, such as to set back the regulated temperature of a room when the room is not occupied. In different embodiments, the HVAC system, the security system, or both the HVAC system and the security system, can incorporate wireless CO sensors and/or wireless smoke or fire detectors. In an embodiment wherein the security system incorporates wireless CO sensors and wireless smoke or fire detectors, and the HVAC system does not, when the security system reports a fire event, the HVAC system can advantageously use the reported information to turn itself off, and when the security system reports a CO event, the HVAC system can advantageously use the reported information to turn itself on.

A typical HVAC system can include a plurality of different regulated zones—each zone controlled by a separate thermostat installed in the zone. The present disclosure can include a plurality of separate wireless thermostats, and each wireless thermostat can discover and communicate with each other wireless thermostat installed on the system, to permit adjustment and display of any one wireless thermostat's conditions from any of the other wireless thermostats.

Pursuant to the present disclosure, each wireless thermostat preferably includes a GUI (graphical user interface) to provide an easily programmable thermostat to allow a user to take full advantage of the programmable features and functions of the programmable thermostat. In addition, each wireless thermostat and GUI is not limited in the extent of the information which can be displayed, and can display, for example, the temperature of another room, the outdoor temperature, or the air quality—if an air quality sensor is installed on the system. The air quality sensor can be configured and arranged to provide outdoor pollen count, ozone level, dust/dander level etc., which could be of interest to people suffering from respiratory conditions, such as airborne allergies, asthma and emphysema.

One or more of the thermostats or wireless remotes can incorporate an easily programmable feature whereby, by merely pressing a button switch one or more times, the temperature of the zone controlled by the thermostat or wireless remote can be set back for a period of time determined by the number of times the switch is depressed. Alternatively, the display can incorporate a touch sensitive surface layer, allowing a user to indicate system commands by touching the screen in predetermined regions. The system commands may be organized in a hierarchical menu structure, navigable via the touch sensitive display. In addition, the wireless thermostats can be remotely controlled by other wireless thermostats in other rooms or from mobile locations within a home.

In accordance with one embodiment of the disclosure, a wireless climate controller is adapted for wirelessly communicating with an HVAC control system as well as one or more other wireless devices. The climate controller includes a graphic user interface for interacting with a user and receiving control inputs therefrom. Control inputs are sent via wireless medium to both the HVAC control system and the other wireless device(s). With this approach, the wireless climate controller can be used to communicate with and control a variety of systems and other wireless devices.

In an alternate embodiment of the present disclosure, a wireless graphic thermostat is configured and arranged to communicate with a remote security system. The wireless graphic thermostat is adapted to receive control inputs and to use the control inputs to generate and communicate control signals to an HVAC system and the remote security system. The control inputs are received, for example, via an input arrangement at the wireless graphic thermostat (e.g., keypad, touchscreen or infrared remote control), or via signals received from one or both of the HVAC system and the security system, via wired and/or wireless links. In some implementations, the wireless graphic thermostat displays information received from the remote security system.

### BRIEF DESCRIPTION OF THE DRAWINGS

The foregoing objects and advantages of the present disclosure for an interconnected HVAC system and security system may be more readily understood by one skilled in the art with reference being had to the following detailed description of several embodiments thereof, taken in conjunction with the accompanying drawings, in which:

FIG. 1 illustrates a wireless graphic thermostat arrangement, in accordance with an embodiment of the present disclosure;

FIG. 2 illustrates a system for wireless communication and control, in accordance with an embodiment of the present disclosure;

FIG. 3 illustrates a wireless communications arrangement and approach for establishing communications between a wireless graphic thermostat and a wireless device, in accordance with an embodiment of the present disclosure;

FIG. 4 illustrates a plurality of wireless devices, including at least one wireless graphic thermostat, in various climate control zones, in accordance with an embodiment of the present disclosure;

FIG. 5 illustrates a wireless communications system with a remote control for a wireless graphic thermostat, in accordance with an embodiment of the present disclosure;

FIG. 6 illustrates a wireless communications system with a wireless graphic thermostat and an interactive television with remote for controlling the wireless graphic thermostat, in accordance with an embodiment of the present disclosure; and

FIG. 7 illustrates an interconnected wireless security alarm system and wireless HVAC system, in accordance with the embodiment shown in FIG. 2.

### DETAILED DESCRIPTION OF THE DISCLOSURE

In the following description, reference is made to the accompanying drawings, which form a part hereof, and in which is shown by way of illustration particular embodiments in which the disclosure may be practiced. It is to be understood that other embodiments may be utilized, as structural and operational changes may be made without departing from the scope of the present disclosure.

According to an example embodiment of the present disclosure, a wireless graphical thermostat uses common wireless infrastructure to communicate both HVAC and other control data respectively to an HVAC system and another remote wireless device or system. The wireless graphical thermostat includes a wireless communications circuit, e.g., a transceiver or a combination of discreet transmitters and receivers, for communicating the data. A graphic display is used to present information relative to the communicated data and/or control selections for the HVAC system or the remote wireless device. For instance, HVAC control selections can be displayed in a user-friendly manner so that a user viewing the display can readily ascertain the available control selections. Information relative to the remote wireless device, such as the type of device, allowable control inputs and other information can be displayed. A user input device receives control input that is selectively communicated via the wireless communications circuit to the HVAC system and/or the remote wireless device, depending upon the implementation.

In one implementation, the wireless graphic thermostat is adapted to display information about the remote wireless device and to relay control inputs from a user thereto (e.g., acting as a multifunctional remote control input device with graphic display capabilities). Users can input control selections relating to the displayed information to the wireless graphic thermostat, which then communicates the input to the remote wireless device for controlling the operation thereof. For example, when the remote wireless device is part of a security system, security type data sent from the security system to the wireless graphic thermostat is displayed at the wireless graphic thermostat. Control signals at the wireless graphic thermostat (e.g., programmed controls and/or user inputs) are sent to the security system. Correspondingly, control signals received from the security system can be used by the wireless graphic thermostat for controlling HVAC type equipment. In another example wherein the remote wireless device is another thermostat, data such as temperature, timing and other typical thermostat settings is sent to the wireless graphic thermostat from the remote thermostat for display. User inputs relating to the remote thermostat's information are received at the wireless graphic thermostat and sent to the remote thermostat. With these approaches, the wireless graphic thermostat can be used to control another remote wireless device, allowing users to remotely control the other device and further imparting functionality to the other device (e.g., input and display functionality).

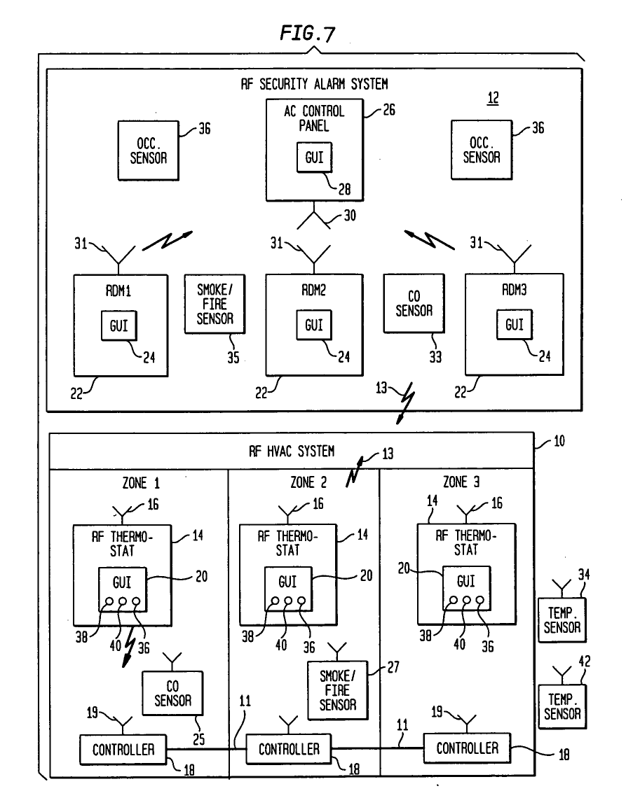

In another example embodiment of the present disclosure, a wireless graphic thermostat and a security system share a wireless communications medium for relative operation, control and communication. For instance, there may be times or situations where HVAC conditions may affect security settings or vice-versa. Further, there may be situations where both HVAC and security settings may be collectively changed. For example, when a person leaves the home for a time, security and environmental features may both require changes. As a more particular example, a family leaving on vacation may want to increase the security level, decrease the temperature or set other security and environmental conditions. Upon return, these conditions would be set for occupation of the home. In these and other situations, the wireless graphic thermostat is used to set a particular condition, indicating a state of occupation of the home. These conditions are used by both HVAC and security systems to control the respective systems as a function of programmed settings. With this approach, a single input that is received at the wireless graphic thermostat is used to affect a plurality of control functions. Additional implementations of the present disclosure relating to both HVAC and security applications are discussed further below in connection with FIG. 7.

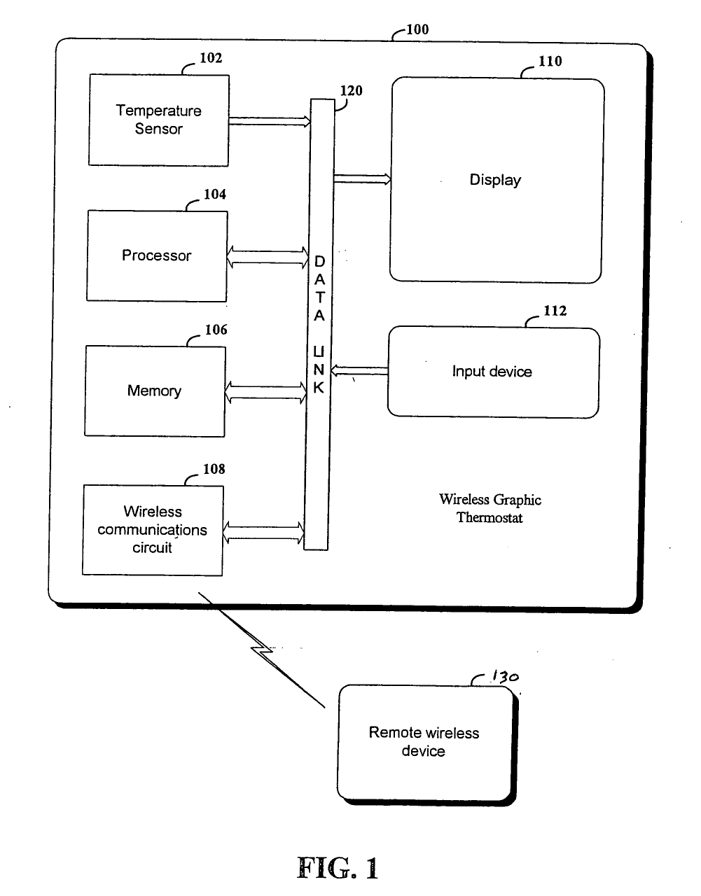

FIG. 1 shows a wireless graphic thermostat 100 adapted to communicate with a remote wireless device 130 via a wireless communications link 108, according to another example embodiment of the present disclosure. The wireless graphic thermostat 100 includes a temperature sensor 102, processor 104, memory 106 and a data link 120 (i.e., a data bus) that facilitates communications in the wireless graphic thermostat. The processor 104 is programmed for conventional thermostat functionality including generating control communications for an HVAC-type system, such as heating, cooling and fan control signals, in response to programmed parameters. A display 110 and an input device 112 (e.g., keypad, touch screen or pointing device) respectively display information and receive input for setting the parameters used by the thermostat processor 104. These parameters can be stored in the memory 106 and accessed by the processor 104 for execution.

The display 110 and input device 112 also facilitate control of the remote wireless device 130. Information relating to the remote wireless device 130 is displayed at the display 110 and inputs received at the input device 112 are communicated to the remote wireless device. In some instances, the information displayed is received from the remote wireless device 130 via the wireless communications link 108, and in other instances the displayed data is stored at the wireless graphic thermostat 100. In addition, when the wireless thermostat 100 discovers (receives communications from) a new remote wireless device, an indication of the new remote wireless device can be displayed at the display 110. With this approach, users at the wireless graphic thermostat 100 can control the remote wireless device 130. In addition, the wireless graphic thermostat 100 can be used to control one or more of a variety of remote wireless devices, such as a remote thermostat, a security system or others using common wireless communications infrastructure. For example, environmental and/or security settings for a dwelling having equipment controlled by the remote wireless device 130 and the wireless graphic thermostat 100 can be simultaneously set as a function of inputs at the wireless graphic thermostat 100.

The wireless communications link 108 is implemented using one or more of a variety of devices, depending upon the application and available equipment. In one instance, the wireless communications link 108 includes a wireless radio frequency (RF) transceiver adapted for sending and receiving RF signals to and from the remote wireless device 130. In another instance, the wireless communications link 108 includes a discrete transmitter and a discrete receiver for communicating with the remote wireless device 130.

Optionally, the wireless graphic thermostat 100 stores data for the remote wireless device 130 in the memory 106 and recalls the stored data for display and/or for sending control signals to the remote wireless device 130. For example, information regarding the remote wireless device 130 or equipment that the remote wireless device controls can be stored at the wireless graphic thermostat 100 and displayed thereat to facilitate user interaction with the remote wireless device. In addition, the stored information can be used to send control signals to the remote wireless device 130, for example by providing identification information to be included with wireless signals intended for the remote wireless device. The wireless graphic thermostat 100 thus stores and uses information for temperature control, security control, device identification and others for the remote wireless device 130.

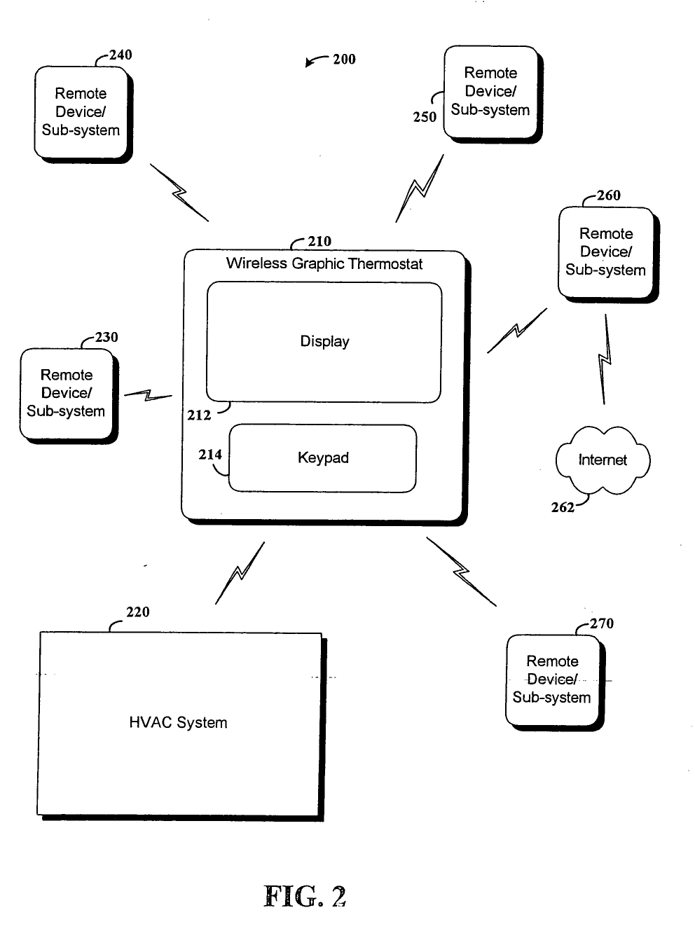

FIG. 2 shows a system 200 having a plurality of devices including a wireless graphic thermostat 210 and controllable using a common wireless communications approach, according to another example embodiment of the present disclosure. The wireless graphic thermostat 210 may be implemented in a manner similar, for example, to the manner discussed above in connection with the wireless graphic thermostat 100 of FIG. 1. A display 212 and an input keypad 214 respectively serve to display information and receive inputs for devices including an HVAC system 220 and several remote device/sub-systems 230, 240, 250, 260 and 270. The remote device/sub-systems communicate using wireless signals and a common communications platform. The wireless graphic thermostat 210 is also programmable, using inputs at the keypad 214 and/or received from one or the remote device/sub-systems, such that the display 212 and keypad 214 can be used as an interface for a multitude of wireless devices.

Optionally, one or more of the remote device/sub-systems is also used for controlling the HVAC system 220. For instance, the remote device 230 may include a remote thermostat for controlling a particular zone in a dwelling. Settings at the remote thermostat 230 are made using the wireless graphic thermostat 210 as a user interface, with inputs at the keypad 214 being used to make the settings at the remote thermostat. In this instance, the HVAC system 220 is controlled using both the remote device 230 and the wireless graphic thermostat 210, with settings and detected conditions at each device being used by the HVAC system. In one implementation, the remote device 230 communicates directly to the HVAC system 220, and in another implementation, the remote device 230 communicates with the HVAC system 220 via the wireless graphic thermostat 210.

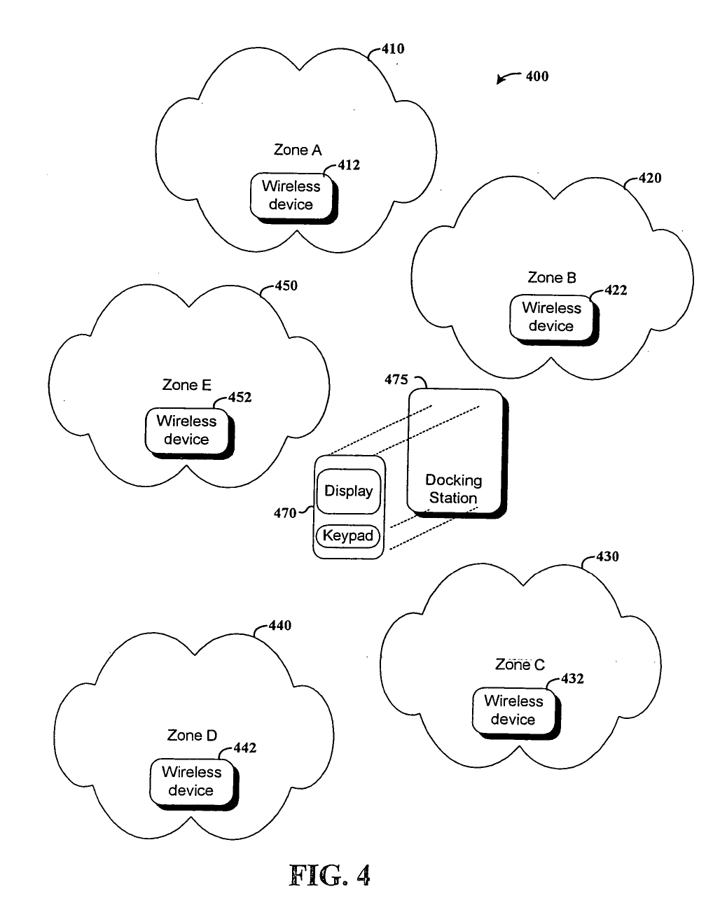

In one implementation, one of the remote device/sub-systems 240 includes a condition-sensing device (e.g., temperature and/or humidity), with the condition information being available to the wireless graphic thermostat 210 for controlling environmental conditions. For example, remote temperature sensing devices can be located in a variety of locations in a dwelling and used to achieve climate control for the particular location in which the temperature sensing devices are located. An example application of such an approach is discussed further below in FIG. 4.

In one instance, the remote condition-sensing device 240 is an outdoor condition sensor, with the wireless graphic thermostat 210 displaying the outdoor condition(s) on the display 212. For instance, using a wireless solar powered or battery powered sensor, outdoor temperature and/or humidity can be viewed from within a dwelling and without necessarily wiring the sensor for power or communications. This approach offers a convenient manner to ascertain weather conditions from within a dwelling.

The outdoor temperature and/or humidity sensed by the outdoor condition sensor 240 can also be used for environmental control of a dwelling, for example, with interior climate settings being implemented relative to the outdoor temperature and/or humidity. For instance, due to exterior temperatures and associated radiation loss or gain, a particular temperature setting will feel differently to occupants within a dwelling. In this regard, to achieve a consistent feel for a temperature setting, the wireless graphic thermostat 210 uses the outdoor temperature and/or humidity sensed by the outdoor condition sensor 240 to automatically adjust user-set parameters such as temperature. When the outdoor temperature is relatively cold (e.g., below zero degrees Fahrenheit), an interior temperature setting of 70 degrees Fahrenheit will feel differently than when the outdoor temperature is more moderate, for example, 50 degrees Fahrenheit. In such an instance, the wireless graphic thermostat 210 automatically increases the interior temperature setting to accommodate radiation heat loss, for example by setting an interior temperature set point about a degree Fahrenheit higher. Similarly, when the outdoor temperature is relatively high (e.g., above 90 degrees Fahrenheit), the wireless graphic thermostat 210 can be programmed to automatically lower a cooling temperature setting to achieve a similar feel to occupants within a dwelling. These approaches are particularly useful in applications where radiation gain or loss is particularly prevalent, for instance, in a location having a relatively large amount of window space.

In another implementation, the remote device/sub-system 250 is a carbon monoxide (CO) sensor that monitors CO levels within a dwelling for which the HVAC system 220 is used. The monitoring of CO levels in connection with HVAC equipment is useful to ensure proper operation of the HVAC equipment, which can generate undesirable CO levels when improperly functioning. When the CO sensor 250 detects CO levels that are beyond a particular level considered dangerous, the dangerous condition is communicated to the wireless graphic thermostat 210. In response, the HVAC system 220 is turned off. Optionally, any CO generating portions of the HVAC system, such as a gas burner, are turned off while continuing to run air movement fans to remove the CO. The wireless graphic thermostat 210 optionally includes an alarm device that is used to create an alarm (e.g., audible, visual or otherwise) in response to the CO sensor 250 detecting a dangerous CO level. In a more particular implementation, the wireless graphic thermostat 210 is adapted to initiate an external alarm notification, for example via telephone or the Internet, to indicate the alarm condition.

In another implementation, one of the remote device/sub-systems 260 is an Internet appliance adapted for communicating with the Internet 262. For example, a computer using a wireless communications link in an ad-hoc type communications node can communicate with the wireless graphic thermostat 210 for controlling settings thereof and/or communicating other information received via the Internet 262. In one instance, the Internet appliance 260 is adapted to receive inputs including access control information (e.g., a password or other security control data) via the Internet 262 by a user desiring to input control selections to the wireless graphic thermostat 210. For example, a homeowner wishing to make HVAC system settings from a remote location can communicate with the wireless graphic thermostat 210 via the Internet 262 and the Internet appliance 260. Optionally, the wireless graphic thermostat 210 provides information relating to the type of graphic display information displayed at display 212, with the information being used by the Internet appliance 260 to communicate the information to the homeowner via the Internet 262. The remote Internet location from which the homeowner is accessing the wireless graphic thermostat uses the information to create a graphic display that resembles information typically shown at the display 212. With this approach, a homeowner can interact with the wireless graphic thermostat 210 from any Internet access point and a common graphic interface.

In still another implementation, the remote device/sub-system 270 is an air exchange system for a dwelling in which the wireless graphic thermostat is located. The air exchange system 270 can be controlled using inputs at the keypad 214, with information relative to the air exchange system being displayed at the display 212. Settings of the HVAC system 220 and the air exchange system 240 are optionally coordinated, for example as a function of temperature detected by the wireless graphic thermostat 210 and/or other conditions, such as outdoor temperature detected using an approach similar to that discussed above. For instance, when the HVAC system 220 is in a cooling mode, the air exchange system 270 can be controlled to exchange less air when outdoor conditions are relatively high in humidity or temperature to lower the cooling load on the HVAC system. Similarly, when the outdoor temperature is very low, the air exchange system 270 can be controlled to exchange less air to lower the heating load on the HVAC system 220.

The air exchange system 270 may further be controlled with the wireless graphic thermostat in connection with the CO sensor 250, with the air exchange system being turned on when a high or dangerous level of CO is detected. Various operation modes of the system 200 can be set in connection with the air exchange system 270. For instance, when a high but not dangerous CO level is detected by the CO sensor 250, the air exchange system 270 can be turned on while continuing to run the HVAC system 220. When a dangerous CO level is detected, CO generating portions of the HVAC system can be disabled while continuing to run the air exchange system 270.

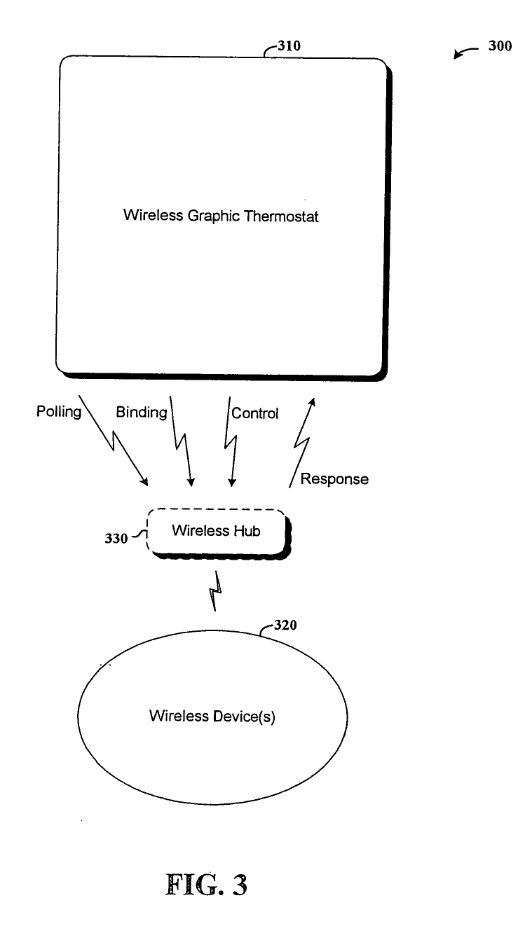

Communications and discovery between wireless graphic thermostats and other devices and/or systems as discussed herein can be effected using one or more of a variety of approaches. FIG. 3 shows one such approach involving a wireless communications arrangement 300 that facilitates communications and discovery between a wireless graphic thermostat 310 and one or more wireless devices 320, according to another example embodiment of the present disclosure. The wireless graphic thermostat 310 is adapted to poll, or sense, a local environment for wireless devices that communicate using similar wireless technology. Information regarding devices that are sensed by the wireless graphic thermostat 310 is displayed at the wireless graphic thermostat, where users can view the information, accept or reject the displayed devices and set configuration parameters for a variety of applications. A wireless hub 330 is optionally implemented for communicating wireless signals between the wireless graphic thermostat 310 and the wireless devices 320. Signals 315 such as polling signals, response signals, binding signals and control signals are passed wirelessly, either directly to the wireless device(s) 320 or via the wireless hub 330.

Communications between the wireless graphic thermostat 310 and wireless devices can be established using a variety of approaches. In one implementation, the wireless graphic thermostat 310 automatically detects signals broadcast by wireless devices for establishing initial communications with the wireless graphic thermostat. In another implementation, the wireless graphic thermostat 310 sends polling signals (e.g., in response to user input) to initiate a response from a wireless device 320 to establish communications. When a response from a particular wireless device 320 is received, a binding signal is sent from the wireless graphic thermostat 310 to the wireless device. The binding signal may include, for example, information that will be required by the wireless graphic thermostat to recognize communications from the wireless device 320, and for the wireless device 320 to recognize the wireless graphic thermostat. The wireless graphic thermostat 310 then uses the binding information when sending control signals for controlling the wireless device 320. With this binding approach, access to the wireless graphic thermostat 310 and/or the wireless device 320 can be controlled for security or other purposes.

FIG. 4 shows a system 400 with a plurality of control zones 410, 420, 430, 440 and 450 respectively having at least one wireless control device 412, 422, 432, 442 and 452, according to another example embodiment of the present disclosure. The wireless control devices are all programmed to communicate via a common wireless platform such that each device can send and receive signals to and from the other devices using a common signal type. At least one of the wireless control devices includes a wireless graphic thermostat as discussed above, for example, in connection with FIG. 1 or 2. For instance, when the wireless control device 412 has functionality similar to that of the wireless graphic thermostat 100, inputs received at the wireless control device 412 can be used to program the other wireless control devices 422, 432, 442 and 452 (e.g., security controllers, temperature sensors or thermostats). Information relating to each of the other wireless control devices is also displayed at the wireless control device 412. Users in zone 410 can use the wireless control device 412 to adjust parameters, such as security settings or temperature, in any of the other zones 420, 430, 440 and 450 via the wireless control device 412. Alternately, two or more of the wireless control devices have functionality similar to that of the wireless graphic thermostat 100, with any one of the wireless control devices being controlled from any one of the two or more wireless control devices. With these approaches, a user can adjust settings for the wireless control devices from a variety of locations and each of the wireless control devices can communicate with one another.

In another implementation, the system 400 uses a portable wireless graphic thermostat 470 adapted to communicate with, display information for and control the wireless control devices 412, 422, 432, 442 and 452. The portable wireless graphic thermostat 470 can be carried by a user into any of the zones and used to communicate with wireless control devices in the particular zone. Optionally, the portable wireless graphic thermostat 470 can be plugged into a fixed docking arrangement 475 that powers the portable wireless graphic thermostat when docked and/or charges batteries therein.

In one instance, the zone in which the user is located is sensed and used to correlate any control inputs made to the portable wireless graphic thermostat 470 to the particular wireless control device in the zone occupied by the user. The user's location can be identified, for example, using wireless communications between the portable wireless graphic thermostat 470 and the wireless control device in the zone or using other means such as motion sensors that are either dedicated to the wireless communications or part of a security system. This approach is useful, for example, for automatically setting temperature conditions at a specific user location to a set point defined by a user with the portable wireless graphic thermostat. For instance, a user need only program his or her preferences to the portable wireless graphic thermostat a single time, with individual rooms being automatically set to the preferences when occupied by the user. In addition, by sensing the location of one or more users, the occupied rooms can be used as a basis for controlling temperature or other environmental conditions in additional zones.

In an alternate implementation, the portable wireless graphic thermostat 470 can be set into a mode for controlling wireless devices in all zones simultaneously with the same inputs and parameters. With this approach, a single input or set of inputs at the wireless graphic thermostat can be used to automatically set other devices (e.g., for setting every room in a house to the same temperature setting). In addition, this approach can be limited in application to a particular type of input effecting control of all zones, such as when a user is setting the wireless graphic thermostat 470 into an “away” mode when leaving a dwelling. During such an “away” period, HVAC type equipment is operated in a relatively low-energy mode. Upon return to the dwelling, a user can execute a “home” mode in which all zones are correspondingly controlled for comfort during occupancy. These “away” and “home” settings can also be effected remotely, for example via a security system, wherein a user placing the security system in “away” or “home” mode automatically generates a corresponding wireless signal that is sent to the wireless graphic thermostat 470.

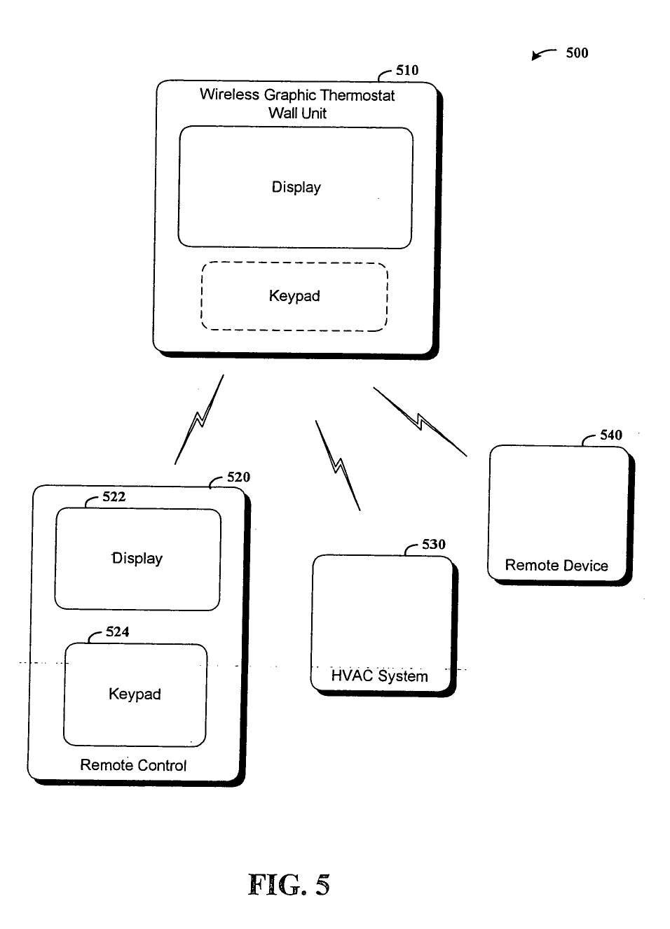

FIG. 5 shows a wireless communications system 500 with a remote control 520 for a wall unit wireless thermostat 510, according to another example embodiment of the present disclosure. The remote control 520 includes a display 522 and a keypad 524, with functionality similar, for example, to a display and keypad on the wireless graphic thermostat 510 and as discussed in connection with the wireless graphic thermostat 100 in FIG. 1. The wireless graphic thermostat 510 communicates with an HVAC system 530 and another remote device such as a security controller, thermostat or temperature sensor using a wireless communications medium. Communications between the wireless graphic thermostat 510 and the HVAC system 530 are wired or wireless, depending upon the implementation. Climate control information is displayed on display 522 for viewing by a user who can input climate control settings via the keypad 524. The control settings are wirelessly transmitted to the wireless graphic thermostat 510 that, in response, transmits control signals to the HVAC system 530 for controlling the operation thereof.

The remote control 520 is implemented in a variety of manners, depending upon the application and desired functionality. For instance, the remote control 520 may be implemented in a manner similar to that discussed in connection with the portable wireless graphic thermostat 470, optionally communicating directly to one or more of the HVAC system 530 and the remote device 540. In another instance, the remote control 520 communicates using a wireless medium used by the wireless graphic thermostat 510 to communicate with the HVAC system 530 and remote device 540. In another still instance, the remote control 520 communicates with the wireless graphic thermostat using another type of communications medium, such as infrared signals. Optionally, the remote control 520 connects to a mounting arrangement, such as the wireless graphic thermostat 510 itself or another mounting arrangement, for example on a wall convenient for thermostat access. The mounting arrangement provides a fixed position for the remote control 520, and also optionally includes an electrical connector for charging the remote control 520.

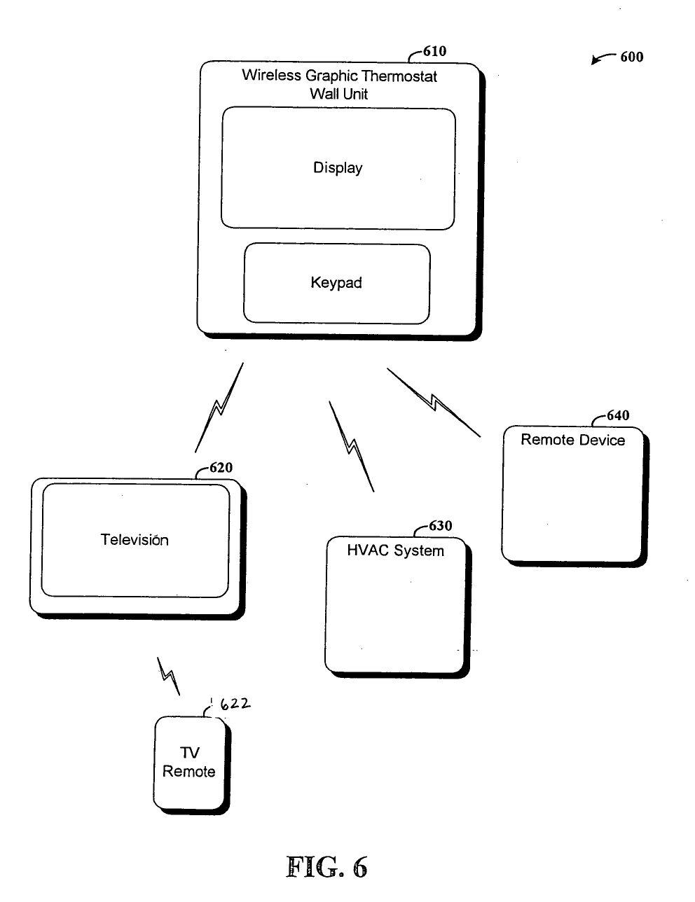

FIG. 6 shows a wireless communications system 600 with a wall unit wireless graphic thermostat 610 and an interactive television 620 with remote 622 for controlling the wireless graphic thermostat, according to another example embodiment of the present disclosure. The system 600 is similar to the system 500 shown in FIG. 5, with the wireless graphic thermostat 610 communicating control signals to an HVAC system 630 and a remote device 640 such as a security system (or controller therefor). In this embodiment, the television 620 and remote 622 are adapted for providing remote input to the wireless graphic thermostat 610. The wireless graphic thermostat 610 includes a television channel modulator and/or a National Television System Committee (NTSC) output that permits display/interaction with the television 620. Information relating to the control of the HVAC system 630 is displayed on the television 620 by the wireless graphic thermostat 610 so that selections from the displayed information can be made via the television remote 622. Selections (control inputs) received at a television remote 622 are sent to the wireless graphic thermostat via the television and used for controlling one or more of the HVAC system 630 and the remote device 640.

Referring to FIG. 7, an example of an embodiment of the present disclosure is shown having an interconnected wireless RF HVAC system 10 and wireless security alarm system 12 which are interconnected and communicate with each other by signals 13.

The bottom of FIG. 7 illustrates a wireless HVAC system 10 incorporating an RF wireless control system using a selected RF frequency, modulation and a set of protocols. A typical modem HVAC system communicates over a local network via a local network system bus 11, with different components of the HVAC system having different digital addresses in the local network. The wireless HVAC system typically includes a plurality of zones, shown as zones 1, 2 and 3, and a plurality of wireless controls 14 which can comprise enhanced wireless thermostats, generally one for each zone of the HVAC system. Each enhanced control or thermostat has a short-range wireless transceiver and antenna 16 for communicating with and controlling a controller 18 having an antenna 19 of the wireless HVAC system and also other components as explained herein. Each thermostat 14 of the HVAC system is also enhanced with a graphical user interface (GUI) 20, such that it can be programmed to include conventional thermostat functionality with a user-friendly presentation. The enhanced thermostat permits easy user interaction and provides the ability to display and integrate various accessory sensors and remote controls. The HVAC system can also incorporate one or more wireless CO sensors 25 and one or more wireless smoke or fire detectors 27.

The top of FIG. 7 illustrates the wireless RF security alarm system 12, which also incorporates a wireless control system using the same selected Wireless technology and modulation as the wireless HVAC control system 10. The security system 12 also uses a set of protocols, which includes a set of common protocols implemented by both the HVAC system and the security system. The wireless security alarm system 12 includes a plurality of wireless controls in the form of Remote Display Modules (RDMs) 22, each having a keypad or a GUI 24, for communicating with and controlling the security alarm system and also other components as explained herein.

The wireless security alarm system can be a system such as an Ademco security alarm system wherein an AC powered control panel 26, such as an Ademco Quickmate™ control panel, is provided at a central accessible location, such as at an entrance to a building protected by the security alarm system. The control panel 26 can provide a display of all pertinent parameters and conditions of the security alarm system, and also provides inputs, such as a Graphical User Interface (GUI) 28, to allow a user to view the status of the security alarm system and also to enter data into and access and control the security alarm system.

The control panel also includes a local wireless transceiver and antenna 30 to wirelessly transmit periodic messages on the present status of the security alarm system to the plurality of battery powered Remote Display Modules (RDMs) 22 provided at a plurality of locations throughout the building. Each battery powered RDM 22 includes a wireless transceiver and antenna 31 to receive the local wireless transmissions from the transmitter at the control panel, such that each wireless keypad RDM can also provide an accurate display of the present status of the security alarm system, and also to transmit signals to the control panel 26 to communicate with and control the wireless security alarm system.

The wireless security alarm system can also include one or more wireless CO sensors 33 and one or more wireless smoke or fire detectors 35.

Pursuant to the present disclosure, the common wireless transceiver technology, including common frequency, modulation and the set of common protocols, provide interconnectivity and communication between the HVAC system 10 and the security alarm system 12. The common wireless transceiver technology provides control of the wireless HVAC system 10 from either the enhanced wireless thermostats 14 or the security system wireless RDMs 22, and also provides control of the wireless security alarm system from either the security system wireless RDMs 22 or the enhanced wireless thermostats 14.

Since the two systems share the same wireless technology, the wireless security alarm system and the wireless HVAC system can provide access to features now available from both systems. For example, the selection of which HVAC sensor information to use can be determined by room occupancy information provided by the room occupancy motion sensors 36, typically IR sensors for sensing the presence of an occupant of a room, of the security alarm system. The combination of the two systems can provide an automatic control of the HVAC system based on the state of the security alarm system, such as to provide an automatic setback of the HVAC system based on the room occupancy sensors to provide energy savings of the HVAC system, or in embodiments wherein the security system includes a CO sensor 15 and a smoke or fire detector 17, and the HVAC system does not, to turn off the HVAC system during a fire event, or to turn on the HVAC system during a CO event.

The security system might also include a feature whereby a wireless component allows a user to merely press a button to select a security armed condition when the user is leaving the premises or retiring to bed for the evening, and that command could be communicated to the HVAC system to place the HVAC system in a setback, energy conserving mode.

If a wireless security alarm system 12 is already installed in a home, the homeowner might purchase an enhanced replacement thermostat 14 as described herein. All of the above features could be options in buying and installing an improved wireless HVAC control system. Since the two systems share a common wireless technology, the security alarm system and the HVAC system can detect the presence of each other and provide access to the features described herein which are now available because of the combination of the two systems.

This feature of a common wireless technology permits controls for HVAC systems and controls for security alarm systems to interact without requiring special installations between the two diverse systems or special programming requirements.

The interconnected HVAC system and security system need not include an extensive number of wireless components. For instance the interconnected HVAC system might include a single wireless component to enable it to communicate with the security system, or the interconnected security system might include a single wireless component to enable it to communicate with the HVAC system.

Additionally, the HVAC system may provide a wireless bridging circuit or component for allowing communication between wireless components that may use diverse wireless technologies and protocols. For example, a security system using IEEE 802.11g may be given access to an enhanced wireless thermostat using Bluetooth via the HVAC system. The HVAC system receives the data request or control signal from the security system via IEEE 802.11g and forwards it to the appropriate thermostat via Bluetooth. The advantage in such a system is the interoperability with a wider range of components and systems, and the selection of wireless technologies that are most appropriate for each specific circumstance, for example, the system may use Bluetooth for short-range, intra-room, communication, IEEE 802.11x for medium-range, inter-room, communication, and RF for long-range, multi-building communication.

The creation of this ad hoc wireless infrastructure can be expanded with additional user or manufacturer installed devices that require an infrastructure for display and/or communications. For example, a car could send a wireless signal that it is low on gas or has low tire pressure to remind a person who is arming the security alarm system when leaving the house. Similarly, a wirelessly controlled appliance might require service. The wireless infrastructure could also be used to communicate with these devices to take appropriate action.

Since some of these subsystems may include wide area communications means (e.g. the security alarm system may provide Internet connectivity and remote control), this wireless infrastructure can extend remote control of all its devices to the Internet. Most of these features can be accomplished with minimal user set up and with simplicity, often permitting do-it-yourself installation.

One of the strengths of this approach is that each of the subsystems retains its own market channels and installers to create a “whole is greater than the sum of its parts” system automatically by using compatible wireless transceiver technology.

When the wireless HVAC system has more than one zone and more than one wireless thermostat, the different wireless thermostats 14 can discover the presence of each other and permit adjustment and display of any one thermostat's conditions from any of the other thermostats, such as, for example, to permit the wireless thermostat of zone 1 to display the conditions of the wireless thermostat of zone 2 and to control the controller 18 of zone 2.

Moreover, additional wireless temperature sensors 34 can be added to other rooms in the home. One of the common problems of conventional systems is that adjusting the temperature in one room does not necessarily make it comfortable in the room presently being occupied. The present disclosure can include multiple room wireless temperature sensors 34 and a remote control to permit a user to instruct the HVAC system to use the information from a particular temperature sensor 34 or from a room presently being occupied, thereby making the occupied room comfortable.

A wireless thermostat could be designed to select a particular mode of operation and can be installed near the house entrance or in a bedroom. For example, when leaving, one could select an “away” mode by a control 38 that would send a signal, thus triggering selected temperature settings (e.g., setbacks) for the desired mode. At night, one could select a temperature “night” mode by a control 40 to set back the thermostats around the house.

One or more of the wireless thermostats or wireless remotes can also incorporate an easily programmable feature whereby, by merely pressing a button switch 36 one or more times, the temperature of the zone controlled by the thermostat or wireless remote can be set back for a period of time determined by the number of times the switch is depressed. For instance, each pressing of the switch can set back the temperature setting for one hour, or two or more hours, such that a set back period of a selected number of hours is selected by pressing the switch a given number of times. Moreover, that command of the easily programmable switch can be communicated to the security system to arm the security system during the set back period.

Each wireless remote control can be a simple battery powered device, or a rechargeable device, or a device mounted on the wall that is AC powered when mounted on the wall and battery operated when removed from its mounting and used in a mobile mode.

A wireless remote control device could also include a TV channel modulator or NTSC output to permit display of the condition of the HVAC system or the security alarm system on a conventional TV display.

A wireless, solar powered outdoor temperature sensor 42 can also be added. The outdoor temperature sensor can be placed anywhere outdoors on the premises, and an indoor wireless thermostat 14 could sense its presence and be able to display its information on its GUI 20. Indoor air quality sensors could be added in a similar fashion.

While several embodiments and variations of the present disclosure for an wireless interconnected HVAC system and security system are described in detail herein, it should be apparent that the disclosure and teachings of the present disclosure will suggest many alternative designs to those skilled in the art.

1. A wireless graphic thermostat for use with a remote system having a wireless communications link, the wireless graphic thermostat comprising:
a wireless communications circuit configured and arranged for wirelessly communicating with the remote system for sending data regarding the wireless graphic thermostat and for receiving data regarding the remote system, the wireless communications circuit implementing at least one wireless technology and protocol;
a controller configured and arranged to generate control signals for an HVAC (Heating, Ventilating, Air Conditioning) system as a function of environmental control settings received by the wireless graphic thermostat via the wireless communications circuit; and
a display configured and arranged with the controller to display information regarding the environmental control settings and to display information regarding the remote system as a function of the data received via the wireless communications circuit.

2. The wireless graphic thermostat of claim 1, wherein the wireless communications circuit is further configured and arranged to wirelessly communicate information regarding the HVAC system to the remote system.

3. The wireless graphic thermostat of claim 1, wherein the remote system is a security system and sends wireless security data to the wireless communications circuit and wherein the controller and the display are further configured and arranged to display security information regarding the remote system.

4. The wireless graphic thermostat of claim 3, wherein the controller and the wireless communications circuit are further configured and arranged to send security control signals to the security system for controlling the security system.

5. A wireless graphic thermostat comprising:
a temperature sensor;
a thermostat;
a wireless environment device recognition circuit configured and arranged to poll a local environment in which the wireless graphic thermostat resides and to automatically detect and communicate with at least one wireless communications device in the local environment;
a wireless communications circuit configured and arranged for communicating control signals between the wireless graphic thermostat and the at least one wireless communications device for controlling the operation of the wireless communications device; and
a graphic display configured and arranged to display environmental characteristics of the environment in which the wireless graphic thermostat resides and to display information received from the at least one wireless communications device.

6. The wireless graphic thermostat of claim 5, wherein the wireless environment device recognition circuit is configured and arranged to poll a local environment in which the wireless graphic thermostat resides by communicating via a wireless hub to automatically detect and communicate with at least one wireless communications device in the local environment and also communicating via the wireless hub.

7. The wireless graphic thermostat of claim 5, wherein the wireless environment device recognition circuit is configured and arranged to poll a local environment in which the wireless graphic thermostat resides by communicating via a wireless hub to automatically detect and communicate with at least one wireless communications device in the local environment and also communicating via the wireless hub.

8. The wireless graphic thermostat of claim 5, wherein the wireless graphic thermostat is controllable by a wireless controller.

9. The wireless graphic thermostat of claim 5, further comprising an internet connection, said wireless graphic thermostat being controllable over the internet connection.

10. The wireless graphic thermostat of claim 5, wherein the environmental characteristics are displayed on a television and functions of the wireless graphic thermostat are controllable by a television wireless remote.

11. A communication method for use with a remote system having a wireless communications link, the method comprising the steps of:
communicating wirelessly from a thermostat system with the remote system for sending thermostat system data and for receiving data regarding the remote system;
generating control signals for an HVAC system as a function of environmental control settings received at the thermostat system; and
displaying information at the thermostat system regarding the environmental control settings and regarding the remote system as a function of the data received via the wireless communication with the remote system.

12. An interconnected HVAC (heating, ventilating, air conditioning) system and security alarm system comprising:
the HVAC system incorporating a first wireless control system using a selected wireless technology, modulation and set of protocols, including at least one wireless HVAC control having a wireless transceiver for communicating with and controlling the HVAC system; and
the security alarm system incorporating a second wireless control system using the same selected wireless technology, modulation and a set of common protocols as the HVAC wireless control system, and including at least one wireless security control for communicating with and controlling the security alarm system.

13. The system of claim 12, wherein the common same wireless technology, modulation and set of common protocols provide interconnectivity and communication between the HVAC system and the security alarm system.

14. The system of claim 12, wherein the HVAC system is controllable by the at least one wireless security control.

15. The system of claim 12, wherein the security alarm system is controllable by the at least one wireless HVAC control.

16. The system of claim 12, wherein the security alarm system includes room occupancy sensors, and the room occupancy sensors of the security alarm system are used to control the HVAC system.

17. The system of claim 16, wherein a wireless control can instruct the HVAC system to use information from a temperature sensor from a room presently being occupied, as determined by the room occupancy sensors of the security alarm system.

18. The system of claim 12, wherein the HVAC system is controllable by events reported by the security alarm system, the events including: a fire event, an elevated CO level warning and a security system armed event.

19. The system of claim 12, wherein the HVAC system includes a plurality of zones and a plurality of wireless HVAC controls which comprise wireless thermostats.

20. The system of claim 19, wherein each wireless thermostat can discover each other wireless thermostat, to permit adjustment and display of any one wireless thermostat's conditions from any of the other wireless thermostats.

21. The system of claim 12, wherein the HVAC system has a plurality of wireless HVAC controls comprising wireless thermostats, and each wireless thermostat permits display and control of any other wireless thermostat's conditions.

22. The system of claim 12, including a wireless outdoor temperature sensor, wherein at least one of the wireless HVAC control can display the information of the wireless outdoor temperature sensor.

23. An interconnected HVAC (heating, ventilating, air conditioning) system and a second wireless system comprising:
the HVAC system incorporating a first wireless control system using a selected first wireless technology, modulation and set of protocols, including at least one wireless HVAC control having a wireless transceiver for communicating with and controlling the HVAC system;
the second wireless system incorporating a second wireless control system using a selected second wireless technology, modulation and set of protocols; and
a wireless bridging component, included in the HVAC system, for providing interconnectivity and communication between the HVAC system and the second wireless system.

24. The system of claim 23, wherein at least one of the selected first wireless technology, modulation and set of protocols is different than at least one of a corresponding selected second wireless technology, modulation and set of protocols.

25. The system of claim 23, wherein the second wireless system is a security alarm system including at least one wireless security control for communicating with and controlling the security alarm system.
